(19) United States
(12) Patent Application Publication
(10) Pub. No.: US 2005/0288040 A1
(43) Pub. Date: Dec. 29, 2005

(54) Cyclic transmission of notification coordinates in a communication system

(75) Inventors: Frederic Charpentier, Berlin (DE); Joachim Lohr, Darmstadt (DE); Dragan Petrovic, Darmstadt (DE)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/149,585

(22) Filed: Jun. 10, 2005

(30) Foreign Application Priority Data
Jun. 18, 2004 (EP) 04014356.2

(51) Int. Cl. H04Q 7/20

(52) U.S. Cl. 455/458; 455/414.2; 370/432; 340/7.2

(57) ABSTRACT

A method for notification in communication systems is disclosed, in which a sequence of K notification indicators is assigned to a notification identifier like for example a MBMS service identifier or service group identifier of UMTS. The K notification indicators are transmitted one per frame in a cyclic manner. To obtain the notification indicator identifiers indexing the notification indicators in each frame, the plurality of notification identifiers is arranged in a K-dimensional space. Each of the K coordinates of this space can assume Nₙᵢ values, where Nₙᵢ is the number of notification indicators signalled per frame. The i^{th} coordinate X_{i,n} of the point to where the n^{th} notification sequence is mapped in the K-dimensional space, forms the identifier for the notification indicator belonging to the n^{th} notification sequence in the frame with the frame number satisfying the equation i=M mod K.

### BACKGROUND OF THE INVENTION

1. Field of the Invention

This invention is related to communication systems requiring the notification of a special event to one or many receivers. In particular, this invention relates to a notification procedure based on multiple frames.

2. Description of the Related Art

In networks without dedicated connection to each single device, notification of devices about events like incoming calls, arriving data or requests for certain services is necessary when devices assume an idle state with a part of their functions disabled. Network devices monitor the data stream on the network at pre-determined instances of time to look for notifications which tell them that any incident on the network requires their attention.

One popular example of such networks are wireless networks, and in particular cellular networks. As a special examples of a cellular network, UMTS will be explained in more detail herein below.

The paging procedure is one of the most fundamental procedures in a communication system (see Harri Holma and Antti Toskala, “WCDMA for UMTS, radio access for third generation mobile communications, second edition”, John Wiley & Sons, Ltd., for an overview). It is a procedure defined between the mobile terminal (in UMTS called UE) and the radio access network that is used to inform the UE about the occurrence of a special event and triggers an associated behaviour with the UE. Main purpose of the paging procedure is to inform a specific UE about an incoming call (speech or data), but it can also be used to indicate changes in the network configuration and to request all UEs in the cell to read the broadcast control channel (BCCH) where this information is transmitted.

The most typical example for this procedure is the paging of an idle mode UE in order to set up a call initiated by a third party. The paging procedure is illustrated in FIG. 1. An idle mode UE is switched on and registered to the network but has no permanent connection to it. Once registered in the network, each UE is allocated to a paging group, which is characterised by its paging indicator PI 101. In idle mode, the UEs periodically monitor the PICH 100, where the status (active/non active) of the different paging indicators is signalled. When a specific paging indicator is activated, it triggers all UEs in the cell which belong to the corresponding paging group to read the Paging Channel (PCH), check the validity of the paging message received on the PICH and if the page was intended for the complete paging group (general paging) or for the particular UE.

In more detail, each paging group is uniquely defined by two parameters. The first parameter is the paging occasion 102, which specifies the time instants when the UEs belonging to a specific paging group should read the PICH. The second is the paging indicator identifier, which identifies the indicator 101 associated with the paging group of interest within the paging occasion frame 102.

The positions of the paging occasions are defined in 3GPP TS 25.304v5.4.0 “User Equipment (UE) procedures in idle mode and procedures for cell reselection in connected mode” as follows:
Paging Occasions=IMSI mod DRX cycle length+n*DRX cycle length, (1)
where IMSI is the globally unique UE identification number and n is a positive integer. Equation 1 indicates for each UE the system frame numbers of its paging occasions. The system frame numbering (SFN) 103 is a cyclic running time counter used to identify the transmitted frames over time. The SFN can assume values between 0 and 4095. Each frame 102, 104-112 has a length of 10 ms. A definition of SFN can be found in 3GPP TS 25.402v5.3.0 “Synchronisation in UTRAN Stage 2”. Moreover, the time is divided, for paging purposes, into DRX cycles 113 (Discontinuous Reception), which regroup a fixed number of frames (DRX cycle length), here 102 and 106 to 111. In 3GPP, a DRX cycle 113 is a network configured parameter and may vary between 8 frames (0.08 s) and 512 frames (5.12 s). Once per DRX cycle 113, each UE wakes up at the frame 102 corresponding to its paging occasion and monitors the paging indicator of interest 101 that is transmitted over the PICH 100.

The paging indicator identifier related to a specific paging group depends also on the UE identifier IMSI as follows (from 3GPP TS 25.304v5.4.0, cited above):
PI_identifier=(IMSI div 8192) mod Nₚ, (2)
where Nₚ=(18, 36, 72, 144) is the number of paging indicators per PICH frame as defined in 3GPP TS 25.211v5.5.0 “Physical channels and mapping of transport channels onto physical channels”.

If the paging indicator PI 101 corresponding to the paging indicator identifier of the UE paging group is activated during one of the paging occasion frames of the UE paging group, the UE reads the PCH (paging channel).

The physical channel PICH structure is specified in 3GPP TS 25.211v5.5.0. One frame 200 has a length of 10 ms and is subdivided in 300 bits 201, 202 as shown in FIG. 2. The last 12 bits 202 are unused and reserved for further usage. The first 288 bits 201 are subdivided in Nₚ paging indicators where Nₚ is configured by the network. The paging indicators PI are further mapped on paging locations q depending on the SFN in order to combat time-localised interference as shown in the following equation.

$$q = ( PI + ⌊ ( ( 18 \times ( SNF + ⌊ SFN / 8 ⌋ + ⌊ SFN / 64 ⌋ + ⌊ SFN / 512 ⌋ ) ) mod 144 ) \times \frac{Np}{144} ⌋ ) mod Np \qquad ( 3 )$$

Depending on Nₚ, each PI has a length L varying between 2 consecutive bits (Nₚ=144) and 16 consecutive bits (Nₚ=18). When a PI is activated, all corresponding L bits are set to 1. They are set to 0 otherwise.

The performance of the paging procedure is measured by two metrics: the probability of missed event Pₘ and the probability of false alarm P_{f}. A missed event occurs when the UE fails to detect a paging message because of decoding errors due to an unreliable interface between the transmitter and the receiver. A false alarm occurs when the paging decision derived by the UE is positive although this UE was not actually paged. This generally happens since several UEs share the same paging group. A false alarm can be caused by an unreliable interface.

The performance of the paging procedure is strongly influenced by 3 factors: the PICH transmission power, the number of paging indicators per frame Nₚ and the DRX cycle length. The first two factors have a particularly strong influence on the probability of missed event Pₘ (the probability of missing a page), whereas the last two impact mainly the probability of a false alarm P_{f} (the probability of decoding an active page although no dedicated page has been sent). At a fixed PICH transmission power, the probability Pₘ is much higher when Nₚ is set to an high value (e.g. 144) than with a lower Nₚ value (e.g 18). The exact value depends, of course, on the UE receiver performance. This aspect will not be further discussed, but it can be kept in mind that a low Nₚ value implies a lower Pₘ. Unfortunately, this parameter has an opposite effect on the probability of false alarm, and a trade-off is necessary between P_{f} and Pₘ. Indeed, assuming a perfect reception, the probability of false alarm is depending on the inverse of the total number of the paging groups, which is given by the following formula:
Total number of paging groups=Nₚ*DRX cycle length (4)

Some typical values for the probability of false alarm can be found in the right column of Table 1 further below.

With UMTS, a new aspect has been brought into the field of paging with the introduction of Multimedia Broadcast Multicast Service (MBMS).

In MBMS, a service (video clip, data download, etc.) is broadcast over a predefined service area and is received simultaneously by one or many mobiles that have previously subscribed to this service. An overview of the architecture and functional aspects of MBMS can is given in 3GPP TS 23.246v6.2.0 “Architecture and functional description”, and the radio aspects of MBMS are currently standardised in 3GPP TS 25.346v6.0.0 “Introduction of the Multimedia Broadcast Multicast Service (MBMS) in the Radio Access Network (RAN) stage 2”. The main purpose of MBMS is to allow transmission of the same information to several mobiles at the same time (point to multipoint transmission PtM). Therefore the network does not need to set up dedicated links to each of the interested mobiles in order to transmit this data. Three new channels are currently standardised by 3GPP in order to introduce MBMS services into the UMTS system. The MTCH (MBMS Traffic Channel) is foreseen for carrying the MBMS data content itself to several UEs within one cell during a PtM transmission. If only a few UEs are interested in the broadcast service, the network may rely on normal DPCH channels after establishment of separate dedicated radio links (Point-to-point transmission PtP). Finally, two control channels are introduced. The MCCH (MBMS Control Channel) is broadcasting the current MBMS configuration, signals MBMS specific parameters or messages. The MICH (MBMS indicator channel) is used for UE notification purpose.

One of the necessary functionalities to support MBMS is the MBMS notification procedure, with which the network informs the UEs interested in a specific service on the imminence of the transmission and signals the necessary configuration parameters. The main design criteria for this functionality are UE battery consumption, the robustness of the signalling against all kinds of perturbation and a low probability of false alarm. Unfortunately, these design targets might contradict each other, and typically a trade-off is needed between UE battery consumption and the probability of false alarm. For instance, UEs which have joined one or more MBMS services need to run a background process which periodically monitors the MICH. Frequent MICH readings might decrease the probability of false alarm, improve the signalling robustness and decrease the notification delay time, but would severely impact the UE power consumption.

For MBMS, the current working assumption, as presented in 3GPP TS 25.346v6.0.0, cited above, is to reuse the paging procedure as much as possible. Each MBMS service is mapped onto an MBMS service group depending on its MBMS service identifier like an UE is mapped onto a paging group depending on its UE identifier (ISIM). An MBMS service group is characterised by its notification identifier, which is mirroring the paging indicator identifier concept. The mapping function between the MBMS service identifier and the notification identifiers of the corresponding MBMS service group has not been specified and no concrete proposal has been made up to now, but a mapping function similar to the one presented in Equation 2 will be certainly used if finally specified. The number of different MBMS service identifiers currently envisaged is 2²⁴, whereas the number of different MBMS service groups depends on the notification procedure that will be standardised. It is, however, not certain that an MBMS service group concept will be standardised as some proposals presented in 3GPP in R1-040536 “False Alarm on MICH”, 3GPP TSG RAN1 Meeting #37 (Qualcomm) do not require this concept.

Furthermore, a new MBMS indicator channel (MICH) 300 as shown in FIG. 3 is introduced and reuses the same frame structure as the PICH 100 in FIG. 2. It contains Nₙᵢ MBMS notification indicators NI per frame, and its value may be different to the number of paging indicators Nₚ carried per frame by the PICH. Each notification identifier of each MBMS service group is associated with a notification indicator NI 301 within the MICH frame. Depending on Nₙᵢ, each NI is constituted L bits, where L varies between 2 bits (Nₚ=144) and 16 bits (Nₚ=18). When a NI is activated, all corresponding L bits are set to 1. They are set to 0 otherwise. The MICH frames are further regrouped into Modification Periods 302, which should have a length at least as long as the longest DRX cycle considered in the cell. The notified MBMS service groups are the same over a modification period, and the MBMS UEs monitoring the notified MBMS service groups shall read the information broadcast over the MCCH at the next modification period.

The main difference with respect to the paging procedure is that there is no paging occasion concept in MBMS, since an MBMS service notification is signalled over all the frames forming a modification period. This is performed in order to reach all idle mode UEs in the cell. It is currently not specified when an idle mode UE should read the MICH but one possible solution would be to check the MICH at the paging occasion 102 defined by the paging procedure, as the UE has to monitor the PICH in any case for normal paging procedure as shown in FIG. 3. This would lead to power saving, as paging and MBMS notification would require only one receiver activation per DRX cycle.

Because of the absence of the time multiplexing between MBMS service groups realized by the paging occasions in the case of the standard paging procedure, the total number of MBMS service groups is significantly lower than the number of paging groups. The total number of MBMS service groups is straightforward to derive and equals to Nₙᵢ. As for the paging procedure, the MBMS service group size influences the probability of false alarm P_{f} and the probability Pₘ of missing a notification. In order to guarantee a low Pₘ, Nₙᵢ should be set to a low value. This would however have a negative impact on P_{f}. Thus, since the loss of the time separation cannot be compensated by a higher number of notification indicators, the probability of false alarm for MBMS is significantly higher than for the paging procedure, as shown in column 2 of Table 1.

TABLE 1
Probabilities of false alarm P_{f}for MBMS notification with K = 2

| | | | | Paging procedure |
|---|---|---|---|---|
| | | | | false alarm |
| | | | | DRX cycle |
| | | | | length = 1.28 s |
| | | | | 1 paged UE per |
| | | Indicator | Indicator | paging occasion |
| | Current | combination | sequence | Uniform |
| | working | method | method | distribution of UE |
| Np | assumption | K = 2 | K = 2 | Id (IMSI) |
| 18 | 5.6% | 0.6% | 0.3% | 0.04% |
| 36 | 2.8% | 0.2% | 0.08% | 0.02% |

Two main proposals are currently considered within 3GPP in order to lower the probability of false alarm on the MICH. The first one has been proposed by Samsung in R1-040520 “Reducing the false alarm probability on MICH decoding”, 3GPP TSG RAN1 Meeting #37 (Samsung), where a MBMS service group is identified by a particular combination of K notification indicator identifiers signalled by the corresponding notification indicators within one MICH frame. The second proposal from Qualcomm suggests mapping directly each MBMS service identifier onto a sequence of notification indicator identifiers signalled by the corresponding notification indicators over the successive frames composing a modification period (see 3GPP R1-040536 cited above). With this method, a single notification indicator identifier is signalled per frame. From this sequence, the UE reads K indicators in order to decide whether an MBMS service is notified.

Herein below, this first method will be called “indicator combination method” and the latter one will be called “indicator sequence method”.

It is straightforward to notice that both proposals rely on a multi-component message to signal a notification (several notification indicators are used) and not on a single element message (one notification indicator) anymore. The main difference between the proposals is that the indicator combination method uses notification indicator identifiers of the same frame whereas the indicator sequence method considers notification indicators that are spread over several frames. Moreover it should be highlighted that with 3GPP R1-040536 (indicator sequence method), MBMS services are directly notified and the intermediate stage of mapping the MBMS service onto MBMS service group does not exist anymore.

The proposal of 3GPP R1-040520 to map each MBMS service group onto a combination of notification indicator identifiers within the same frame (indicator combination method) has the benefit of increasing the size of the MBMS service group and therefore decreasing the probability of false alarm.

The number of the MBMS service groups is given by the following formula:

$${MBMS}_{gpsize} = ( \begin{matrix}{N}_{ni} \\ K\end{matrix} ) = \frac{{N}_{ni} !}{( {N}_{ni} - K ) ! K !} , \qquad ( 5 )$$

where K denotes the number of considered notification indicators for one MBMS service group within one frame.

With Nₙᵢ=18 and K=2, the number of the MBMS service groups is 153.

The main drawback of this proposal is that, if multiple MBMS notifications are performed simultaneously (within the same frame), it will cause an increase of the probability of false alarm as some overlapping effects are to be feared. This is shown in FIG. 4, where the notifications indicators 401 and 402 are associated with the MBMS service group 1, the notification indicators 402 and 403 are associated with the MBMS service group 2 and the notifications indicators 403 and 404 are associated with the MBMS service group 3. In this case, the simultaneous notification of the MBMS service group 1 and 3 would trigger the UEs interested in the MBMS service group 2, which creates a false alarm for these UEs. Moreover, a simple and implementation feasible mapping between MBMS service group identifiers and notification indicator identifiers has not been proposed so far.

An example of the probability of false alarm Pf for the indicator combination method is given in the third column of Table 1 above.

In 3GPP R1-040536, Qualcomm proposed to directly map each MBMS service identifier into a notification indicator identifier sequence transmitted over the modification period (indicator sequence method). From this sequence, K notification indicators are read by the UE. This is shown in FIG. 4. In the example shown in FIG. 5, K equals 2. Starting with the UE paging occasion 102, the UE reads two notification indicators 501, 502 within frames 503, 504 of MICH 300. If both notification indicators 502, 502 are positive, a notification of the corresponding MBMS service identifier is assumed to be present, and information is received from the MCCH about the cause of the notification.

With this method, the number of the MBMS service identifiers which can be distinguished depends on the number of notification indicators read by the UE. This is given by the following formula:
MBMS_{dist}_{_{—}}_{service}=Nₙᵢ^{K}, (6)
where K denotes the number of the read notification indicators of the notification sequence.

In a sense, the number of distinguishable MBMS services is similar to the number of MBMS service groups as they have the same influence on false alarm probability.

With Nₙᵢ=18 and K=2, the number of the distinguishable MBMS services is 324, which is significantly higher than with the indicator combination method.

Moreover with this approach, the likelihood of overlaps between different notification messages is significantly lower compared with Samsung approach. This makes this solution more robust in case of multiple simultaneous notifications and therefore more appealing.

3GPP R1-040536 proposes to generate the notification indicator identifier sequence with the help of a pseudo-random generator using a shift register structure. A pseudo-random generator iteratively creates a pseudo-random sequence number based on the past of the sequence. Given the generator law, the sequence is fully deterministic and is defined by the initial value (generator seed) and its starting time, which is the beginning of the modification period. Unfortunately this method requires the UE to track down the evolution of the sequence by continuously running the same sequence generator. This latter point is particularly inappropriate, as the UE only needs to know the values of this sequence at the K SFNs where it actually reads the MICH.

An example of the probability of false alarm P_{f} for the indicator sequence method is given in column 4 of Table 1 above.

As highlighted earlier, the MICH transmission power and the length of the notification indicators mainly drive the probability of missed event and this aspect will not be treated in the present invention. As shown in Table 1 above and Table 2 below, the use of a notification sequence appears to currently provide the best performance with respect to the probability of false alarm, but the notification sequence method proposed in 3GPP R1-040536 requires some background processing and therefore is not optimal with respect to the battery lifetime.

### SUMMARY OF THE INVENTION

It is the object of the present invention to provide a notification mechanism based on a MICH structure that guarantees a low battery power consumption of the receiving device and low probabilities of missed notification and false alarm.

This object is achieved by a method according to claim 1, a device according to claim 6, a computer-readable medium according to claim 7, a device according to claim 8, a computer-readable medium according to claim 9 and a communication system according to claim 10.

The object is achieved by assigning a sequence of K notification indicator identifiers to a notification identifier; setting all notification indicators identified by the notification indicator identifiers belonging to said sequence to positive if a notification for said notification identifier is present; and sending said notification indicators via a communication network, wherein notification indicators consist of at least one bit each and are successively transmitted on a channel having a framed structure; the sequence comprises exactly one notification indicator identifier per frame and the sequence is repeated with a period of K frames; the notification identifiers are arranged in a K-dimensional space, K being greater than one; each notification identifier is associated with one set of K coordinates; and the sequence of notification indicator identifiers consists of the K coordinates.

In one aspect of the present invention, a method for notification, to be executed in a device of a communication system, comprises the steps of assigning a sequence of K notification indicator identifiers to a notification identifier; setting all notification indicators identified by the notification indicator identifiers belonging to said sequence to positive if a notification for said notification identifier is present; and sending said notification indicators via a communication network, wherein notification indicators consist of at least one bit each and are successively transmitted on a channel having a framed structure; said sequence comprises exactly one notification indicator identifier per frame; said sequence is repeated with a period of K frames; said notification identifiers are arranged in a K-dimensional space, K being greater than one; each notification identifier is associated with one set of K coordinates; and said sequence of notification indicator identifiers consists of said K coordinates.

In another aspect of the present invention, a device of a communication system, comprising a notification generator and a network interface, is configured to perform a method comprising the steps of assigning a sequence of K notification indicator identifiers to a notification identifier; setting all notification indicators identified by the notification indicator identifiers belonging to said sequence to positive if a notification for said notification identifier is present; and sending said notification indicators via a communication network, wherein notification indicators consist of at least one bit each and are successively transmitted on a channel having a framed structure; said sequence comprises exactly one notification indicator identifier per frame; said sequence is repeated with a period of K frames; said notification identifiers are arranged in a K-dimensional space, K being greater than one; each notification identifier is associated with one set of K coordinates; and said sequence of notification indicator identifiers consists of said K coordinates.

In a further aspect of the present invention, a computer-readable medium has stored thereon instructions that, when executed on a processor of a device of a communication system, cause the device to perform a method comprising the steps of assigning a sequence of K notification indicator identifiers to a notification identifier; setting all notification indicators identified by the notification indicator identifiers belonging to said sequence to positive if a notification for said notification identifier is present; and sending said notification indicators via a communication network, wherein notification indicators consist of at least one bit each and are successively transmitted on a channel having a framed structure; said sequence comprises exactly one notification indicator identifier per frame; said sequence is repeated with a period of K frames; said notification identifiers are arranged in a K-dimensional space, K being greater than one; each notification identifier is associated with one set of K coordinates; and said sequence of notification indicator identifiers consists of said K coordinates.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein

FIG. 1 illustrates an example of a paging procedure as defined in 3GPP R99,

FIG. 2 shows an exemplary structure of a paging indicator channel as defined in 3GPP R99,

FIG. 3 shows an example for a notification procedure for a Multimedia Broadcast Multicast Service as specified by 3GPP

FIG. 4 illustrates the occurrence of false alarm due to overlapping of notification indicators,

FIG. 5 shows another example for a MBMS notification procedure according to an indicator sequence method,

FIG. 6 illustrates the representation of notification sequences with length 3 as a 3-dimensional space,

FIG. 7 depicts a representation of notification sequences with length 2 as a 2-dimensional space.

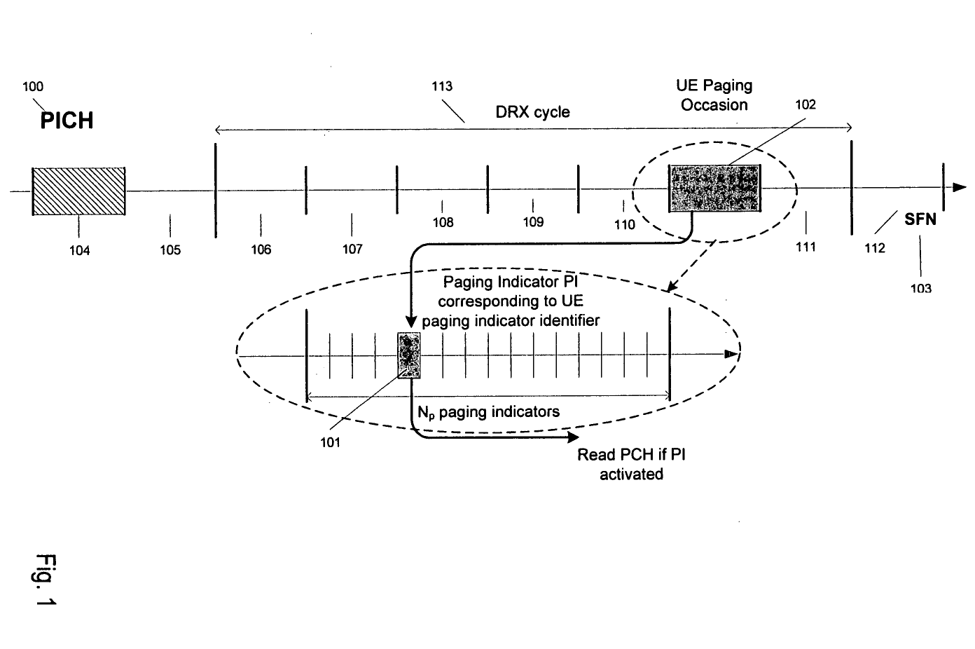

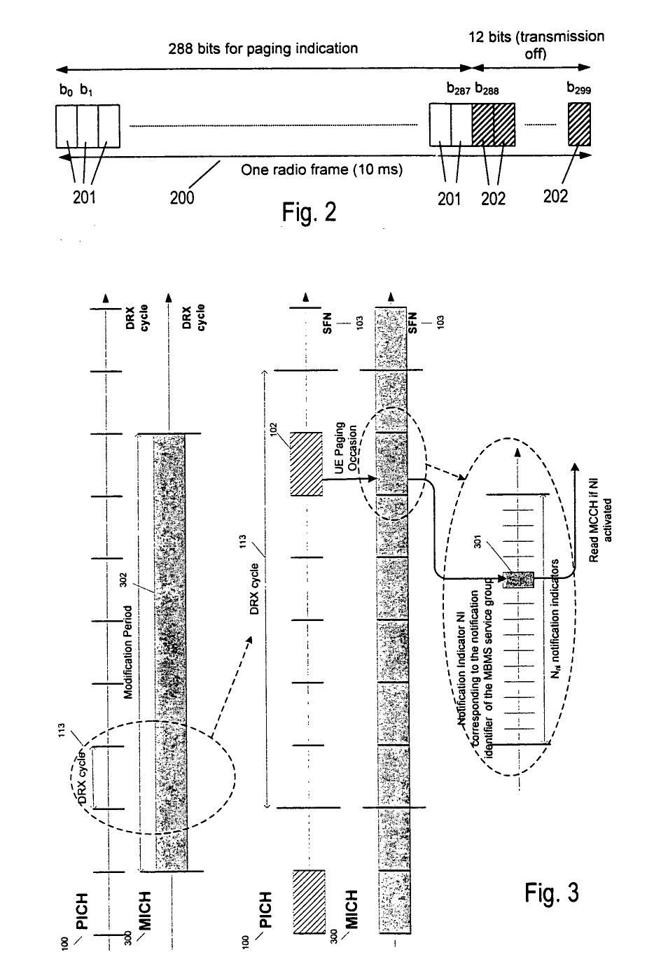

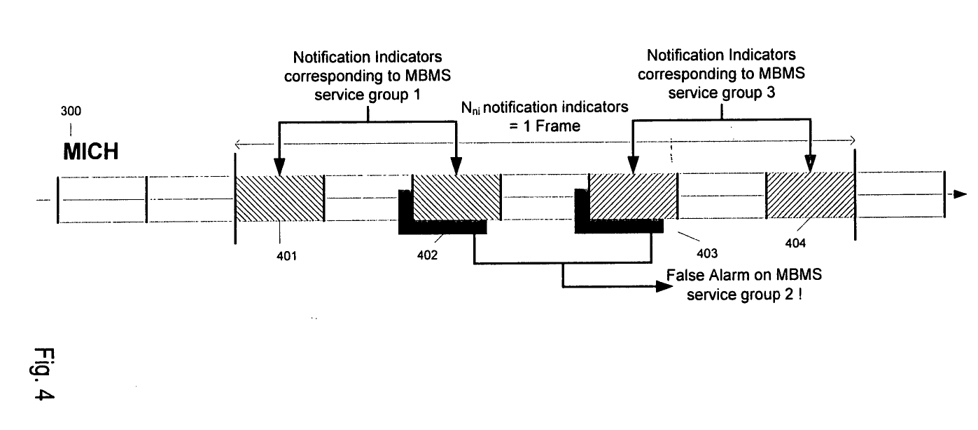

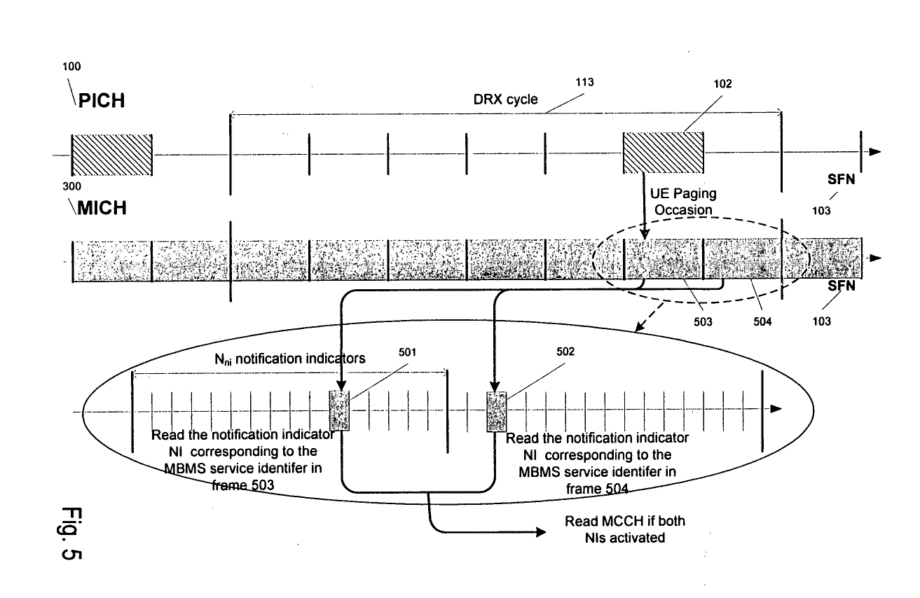

### DETAILED DESCRIPTION OF THE INVENTION

The illustrative embodiments of the present invention will be described with reference to the figure drawings, wherein like elements and structures are indicated by like reference numbers.

The present invention presents a new method for a multi-frame notification messaging based on cyclic transmission of notification coordinates. This method will be called herein below the “cyclic notification sequence method”.

Although the method according to the present invention can be applied to various wired and wireless networks requiring notification and having a framed data structure, it will explained below without loss of generality for the example of MBMS notification in UMTS, like defined by the 3GPP. Other applications are conceivable with wired local area networks or wireless networks of other standards. For example, notifications could be used to wake up devices of a wired local area network.

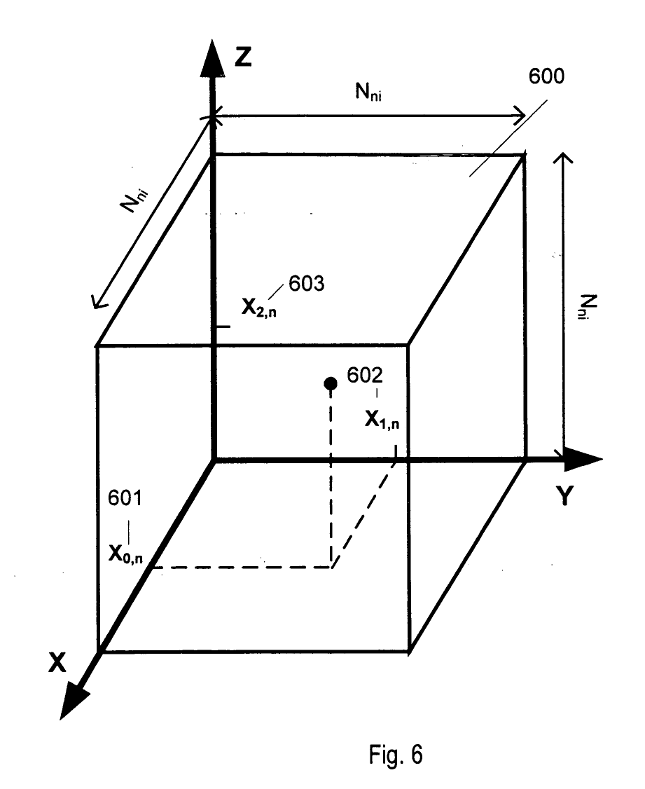

Referring now to FIG. 6, a space 600 is considered containing notification sequences of finite length K. In the example shown in FIG. 6, K has a value of 3. The following equation gives the number of possible notification sequences:
Nb_{notification}_{_{—}}_{sequence}=Nₙᵢ^{K}, (6)

Depending on the number of generated notification sequences, in 3GPP a notification sequence will be associated to a specific MBMS service group or may directly identify an MBMS service. This will depend on the sequence length and on the number of notification indicators per frame. For example, with Nₙᵢ=18 and K=6, the number of notification sequences will be greater than the number of MBMS service identifiers currently foreseen in 3GPP TS 29.846v1.3.1, which would make the introduction of MBMS service group unnecessary.

As illustrated in FIG. 6, the space 600, which represents a plurality of notification identifiers (for example MBMS service group identifiers or MBMS service identifiers), can be seen as a K-dimensional space, and each notification identifier can be identified by a set of K coordinates as follows

$$n = {\sum }_{i = 0}^{K - 1} {X}_{i , n} {N}_{ni}^{i} , \qquad ( 7 )$$

where Xi,n ε[0, Nₙᵢ-1] and n is the notification identifier of the n^{th} notification sequence.

It is proposed to transmit the i^{th} notification indicator identifier of the n^{th} notification sequence with a notification indicator identified by the coordinate X_{i,n} 601, 602, 603 within the frame identified by SFN based on the following rule

If SFN mod K =i

Then activate the X_{i,n}^{th} notification indicator on MICH

End

The coordinates X_{i,n} 601, 602, 603 can be easily computed by the network and the UE. One possibility for computing the X_{i,n} coordinates is given by the following set of iterative equations.
X_{o,n}=n mod Nₙᵢ
∀i ε [1, K−1], X_{i,n}=[(n mod Nₙᵢⁱ⁺¹)−X_{i-1,n}]div Nₙᵢ, (8)
where mod and div are the modulo and the integer division operations.

Another possibility is given by the following equation.
∀i ε [0, K−1], X_{i,n}=(n mod Nₙᵢⁱ⁺¹)div Nₙᵢⁱ. (9)

It shall be noted that both solutions are equivalent.

The proposal presented above has the same probability of false alarm, assuming a perfect decoding of the indicators mapped on the MICH as the indicator sequence method proposal if the length of the notification sequence is the same as the number of indicators read by the UE (indicator sequence method). Analytical and simulation results are shown in table 2 and the simulation assumptions are presented in table 3.

TABLE 2
Probability of false alarm P_{f}and mean time between 2 false alarms

| | | | Indicator | |
|---|---|---|---|---|
| | | | sequence & | |
| | | | cyclic | |
| | | Mean time | notification | Mean time |
| | Indicator | between 2 | sequence | between 2 |
| | combination | false alarms | methods | false alarms |
| K | method | in s. | K = 2 | in s. |
| 1 | 25% | 0.04 | 25% | 0.04 |
| 2 | 19% | 0.05 | 6.2% | 0.16 |
| 3 | 20% | 0.05 | 1.5% | 0.65 |
| 4 | 24% | 0.04 | 0.4% | 2.50 |

TABLE 3
Simulation assumptions for the probability
of false alarm simulations

| Parameter Name | Value |
|---|---|
| Number of tries | 100000 |
| Number of announced MBMS service | 50 |
| Distribution of MBMS service ID | Uniform |
| UE Receiver performance | Error free |
| Number of indicator within 1 MICH frame (Np) | 36 |
| Number of MBMS services notified per frame | 5 |
| Number of MBMS services monitored by the UE | 1 |

As an example, a system is now regarded with Nₙᵢ=18 notification indicators per frame. With a sequence length of K=3, 18³=5832 notification identifiers can be distinguished. If a service has been assigned the notification identifier 3277, the Cartesian coordinates, and therefore the identifiers of the notification indicators, of which the sequence consists, are
X_{0,3277}=3277 mod 18=1
X_{1,3277}=( (3277-1) div 18) mod 18=182 mod 18=2
X_{3,3277}=( (182-2) div 18) mod 18=10 mod 18=10.
In a frame with SFN 1713,
i=1713 mod 3=0,
   therefore in the case of a notification the notification indicator indexed with X_{0,3277}=1 would be set to positive. In the next frame, the notification indicator indexed with X_{1,3277}=2 would be set to positive and in the following frame the notification indicator indexed with X_{3,3277}=10 would be set to positive. The same would be repeated in a cyclic manner ever frame until the end of the notification period.

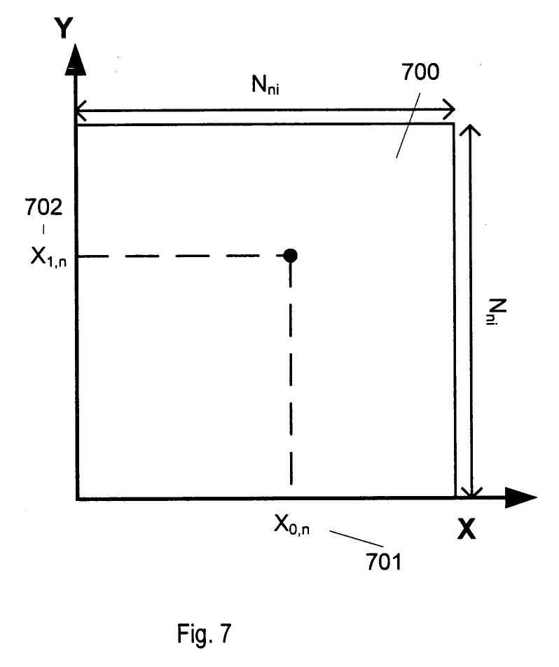

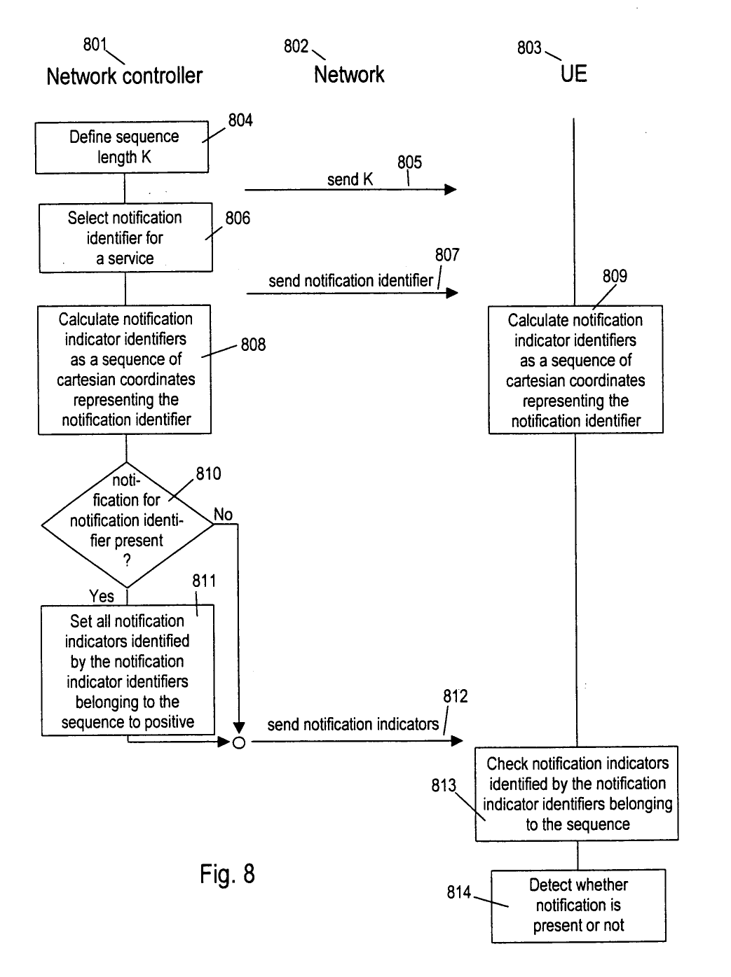

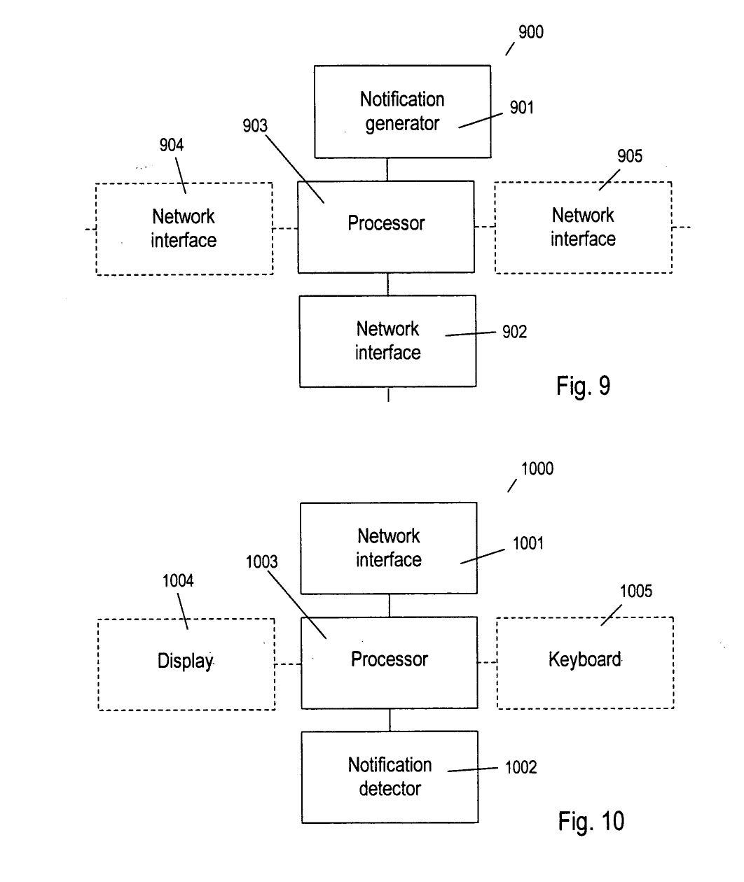

Referring now to FIG. 7, an example with K=2 is shown. The space 700 can be seen as a square of side Nₙᵢ and X_{0,n} 701 and X_{1,n} 702 are the well known (x,y) coordinates.

The n^{th} notification sequence is identified by
n=yNₚ+x, (10)
and the coordinates are easily calculated as follows

$$\{ \begin{matrix} x = n mod {N}_{ni} \\ y = n div {N}_{ni}\end{matrix} . \qquad ( 11 )$$

It should be highlighted that the presented way of calculating the K coordinates X_{i,n} is not unique and several other ways are possible (e.g. starting with the highest coordinates as proposed in Equation (9). The precise choice of particular equations to calculate the K coordinates has no significant impact on the overall complexity or on the UE power consumption. This calculation is only performed once when the UE is signalled the MBMS service identifier it should monitor.

Depending on the number of notification sequences, the notification identifier is associated to an MBMS service group identifier or directly to an MBMS service identifier.

In other applications of the invention, the notification identifier might also be an identifier of the device itself.

Referring now to FIG. 8, an exemplary flow chart is shown, employing the method according to the present invention. Three columns show the activities of a first network device 801 which might be a network controller, a second network device 803, which might be a UMTS UE and a network 802 connecting both. First, network controller 801 defines a sequence length K in step 804 and transmits it over network 802 to UE 803 in step 805. It is assumed that UE 803 has subscribed to a service which has been assigned a notification identifier, for example a service identifier or service group identifier in step 806. UE 803 is informed about this identifier in step 807. K can without problem be re-defined after the notification identifier has been assigned and transmitted. Therefore steps 804 and 805 can also be performed after steps 806 and 807. Now both devices can calculate the sequence of notification indicator identifiers like explained above in steps 808 and 809.

Note that only K and the notification identifier have to be informed to UE 803. If the UE is switched off and switched back on after a longer time, it usually only needs to receive information about K and can determine directly and without other synchronisation than a frame number the notification indicator identifier of the sequence belonging to the actual frame, using the frame number broadcast in the network and the equations above.

If a notification is present for the given notification identifier (“YES” in 810), for example because new data is available to be transmitted, the network controller subsequently sets the notification indicators, one of each frame, identified by the calculated notification indicator identifiers, to positive in step 811. For notification of other notification identifiers, other notification indicators or even the same may be set to positive within the same frame. As all notification indicators had been initialised to negative, this corresponds to a disjunction between all notifications. All notification indicators are broadcast over the network in step 812. They can be received by UE 803 within a suitable time interval. The notification indicators identified by the notification indicator identifier belonging to the sequence can then be checked for their contents and the presence of a respective notification can be detected. In this context, one frame is to be understood as the time unit within which one notification indicator of a sequence is transmitted. This could be a UMTS frame, but also any smaller or larger time unit like for instance a UMTS subframe.

In FIG. 9 an exemplary structure of a device 900 of a communication system is shown, which can send notifications according to the method described above. Among other elements, like processor 903 and interfaces 904, 905 to other networks, it may comprise a notification generator 901 to generate the notification indicators as described above and a network interface 902 to send them, among other data, via a communication network. The notification generator 901 may advantageously be implemented in software to be carried out in a general purpose processor.

A device 1000 of a communication system, adapted to receive and detect notifications sent by device 900, is shown in FIG. 10. It comprises a network interface 1001 to receive notification indicators and other information from the network, and a notification detector 1002 to detect notifications from the received notification indicators. It may further comprise components like processor 1003, display 1004 and keyboard 1005, which are not required to carry out the present invention. Notification detector 1002 may be implemented in software to be carried out in a general purpose processor.

Another embodiment of the present invention relates to the implementation of the above described various embodiments using hardware and software. It is recognized that the various above mentioned methods as well as the various logical blocks, modules, circuits described above may be implemented or performed using computing devices, as for example general purpose processors, digital signal processors (DSP), application specific integrated circuits (ASIC), field programmable gate arrays (FPGA) or other programmable logic devices, etc. The various embodiments of the present invention may also be performed or embodied by a combination of these devices.

Further, the various embodiments of the present invention may also be implemented by means of software modules which are executed by a processor or directly in hardware. Also a combination of software modules and a hardware implementation may be possible. The software modules may be stored on any kind of computer readable storage media, for example RAM, EPROM, EEPROM, flash memory, registers, hard disks, CD-ROM, DVD, etc.

Various embodiments as described above may advantageously reduce the probability of missed notification and false alarm in MBMS notification. Thus, battery consumption of mobile devices can be reduced.

While the invention has been described with respect to the embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

1. Method for notification, to be executed in a device of a communication system, comprising the steps of assigning a sequence of K notification indicator identifiers to a notification identifier;
setting all notification indicators identified by the notification indicator identifiers belonging to said sequence to positive if a notification for said notification identifier is present; and
sending said notification indicators via a communication network, wherein notification indicators consist of at least one bit each and are successively transmitted on a channel having a framed structure;
said sequence comprises exactly one notification indicator identifier per frame;
said sequence is repeated with a period of K frames;
said notification identifiers are arranged in a K-dimensional space, K being greater than one;
each notification identifier is associated with one set of K coordinates; and
said sequence of notification indicator identifiers consists of said K coordinates.

2. The method according to claim 1, wherein in one frame Nₙᵢ notification indicators are transmitted and said K coordinates Xᵢ assigned to said notification identifier n satisfy an equation
$$n = {\sum }_{i = 0}^{K - 1} {X}_{i , n} {N}_{ni}^{i} .$$

3. The method according to claim 1, wherein a transmission order of said notification indicator identifiers within said sequence is determined by a numbering of said frames.

4. The method according to claim 3, wherein an i^{th} coordinate is an identifier of the assigned notification indicator in all frames with a frame number M satisfying an equation i=M mod K.

5. The method according to claim 1, further comprising the steps of defining the sequence length K prior to said step of assigning a sequence of K notification indicator identifiers to a notification identifier; and
sending the value K via a communication network.

6. A device of a communication system, comprising a notification generator and a network interface, configured to perform a method comprising the steps of assigning a sequence of K notification indicator identifiers to a notification identifier;
setting all notification indicators identified by the notification indicator identifiers belonging to said sequence to positive if a notification for said notification identifier is present; and
sending said notification indicators via a communication network, wherein notification indicators consist of at least one bit each and are successively transmitted on a channel having a framed structure;
said sequence comprises exactly one notification indicator identifier per frame;
said sequence is repeated with a period of K frames;
said notification identifiers are arranged in a K-dimensional space, K being greater than one;
each notification identifier is associated with one set of K coordinates; and
said sequence of notification indicator identifiers consists of said K coordinates.

7. A computer-readable medium having stored thereon instructions that, when executed on a processor of a device of a communication system, cause the device to perform a method comprising the steps of assigning a sequence of K notification indicator identifiers to a notification identifier;
setting all notification indicators identified by the notification indicator identifiers belonging to said sequence to positive if a notification for said notification identifier is present; and
sending said notification indicators via a communication network, wherein notification indicators consist of at least one bit each and are successively transmitted on a channel having a framed structure;
said sequence comprises exactly one notification indicator identifier per frame;
said sequence is repeated with a period of K frames; said notification identifiers are arranged in a K-dimensional space, K being greater than one;
each notification identifier is associated with one set of K coordinates; and
said sequence of notification indicator identifiers consists of said K coordinates.

8. A device of a communication system, comprising a notification detector and a network interface, configured to receive and detect notifications sent by the device of a communication system as defined in claim 6.

9. A computer-readable medium having stored thereon instructions that, when executed on a processor of a device of a communication system, cause the device to receive and detect notifications sent by the device of a communication system as defined in claim 6.

10. A communication system comprising:
at least one device, comprising a notification generator and a network interface, according to claim 6,
at least one device, comprising a notification detector and a network interface, configured to receive and detect notifications sent by said at least one device comprising said notification generator, and
a network connecting said devices.
